(19) United States
(12) Patent Application Publication
(10) Pub. No.: US 2025/0299192 A1
(43) Pub. Date: Sep. 25, 2025

(54) Method for Allocating Credit Card Funds to Anonymous Persons and Authorizing Cardless Unidentified Anonymous Payments via Credit Card Terminals

(71) Applicant: Meir Dahan, Tiberias (IL)

(72) Inventor: Meir Dahan, Tiberias (IL)

(21) Appl. No.: 19/231,488

(22) Filed: Jun. 8, 2025

Related U.S. Application Data
(63) Continuation-in-part of application No. 18/142,042, filed on May 2, 2023.

(51) Int. Cl. G06Q 20/40; G06Q 20/38

(52) U.S. Cl. CPC G06Q 20/401; G06Q 20/385

(57) ABSTRACT

A method for allocating money from a credit card account to an unidentified, anonymous person and for enabling a cardless, unidentified, and anonymous payment via a credit card terminal using the allocated amount, including the steps of receiving allocation requests from credit card account holders via online credit card accounts, each request including an allocated amount and an associated non-registered mobile phone number, storing the requests in a credit card provider database, flagging each allocation request as authorized for cardless, unidentified, and anonymous payment, to be completed solely by entry at a credit card terminal of the specified phone number and a one-time password (OTP) sent to that number, and authorizing the payment via the terminal using the allocated amount.

### RELATED APPLICATIONS

This application is a continuation in part of U.S. patent application Ser. No. 18/142,042 filed on May 2, 2023.

### TECHNICAL FIELD

The present invention refers to a method for online allocations of funds from credit card account interface to anonymous, unidentified persons and for online automatic authorization of cardless, unidentified, and anonymous payments of the allocated amounts via credit card terminals.

### RELEVANT PRIOR ART AND DISTINCTIONS

Prior art WO 2014/108916 (Agasha) discloses a system designed to protect sensitive customer information by storing it in a secure database vault during conventional credit card transactions. In Agasha's system, the user performing the payment via a credit card terminal is identified and verified, and both the customer and the business must be pre-registered in order to validate the transaction.

Prior art US 2024/005312 (Tammaji) describes a system that enhances card-based transactions with multi-factor authentication. In this system, the user performing the payment is also identified and verified. It determines the card owner's mobile phone number using the credit card number and sends a one-time password (OTP) to that number to authenticate the transaction.

Prior art US 2007/0255620 (Tumminaro) discloses a system for transferring funds from a sender's phone number to a recipient's phone number. Although it mentions the possibility of sending money to a non-registered person, this is framed as a way to encourage that person to register with the service and system.

In contrast, the present invention differs fundamentally from the above prior art. First of all, it refers to a method for online allocation of money from a credit card account to an anonymous, unidentified person. None of the cited prior art discloses such option. Secondly, the method of the present invention also refers to online automatic authorization of executing a cardless, unidentified, and anonymous payment via a credit card terminal using the allocated money. None of this prior art discloses or hint such option. The present invention relies on non-registered mobile phone numbers as the primary and solely identifiers for cardless, unidentified, and anonymous payments via credit card terminals, using pre-allocated funds.

None of the cited prior art discloses a method for online allocation of money from a credit card account holder to an anonymous, unidentified person, nor do they teach or suggest the online automatic authorization of executing a cardless, unidentified, and anonymous payment via a credit card terminal using those allocated funds.

Furthermore, none of the prior art references disclose the combination of steps and system components as defined and claimed in the present application. For example, none of the cites prior art includes a step of receiving an allocation request from credit card account holder comprising an allocated amount of money, a non-registered mobile phone number, and instructions to authorize a cardless, unidentified, and anonymous payment via a credit card terminal using the allocated amount. In addition, the cited prior art do not include a step of automatic flagging each allocation request as authorized for cardless, unidentified, and anonymous payment via a credit card terminal using a respective allocated amount being valid solely upon manual entry, at a credit card terminal, of a mobile phone number associated with the corresponding allocation request and a one-time password (OTP) transmitted to the associated mobile phone number. As stated further in this disclosure, the term “anonymous person” in this disclosure and the claims refers to an individual about whom nothing is known, beyond the specified mobile phone number, the amount allocated for his usage via credit card terminals, and the fact that the credit card account holder allocates these funds to be used by entering this mobile phone number to the credit card terminal. None of the cited prior art disclosed or suggests such option.

### Thus, the Claimed Invention Overcomes the Limitations of the Prior Art.

### BACKGROUND ART

The present invention provides an effective solution to several common needs and problems, primarily the following:

First, in many cases, a credit card account holder wishes to transfer money using his credit card to another person (the recipient) who does not have a settlement (clearing) agreement with a credit card company. Typically, credit cards cannot be used to transfer funds to private individuals, but only to businesses. In some cases, it is even impossible to pay small businesses-such as babysitters, manicurists, and similar service providers—by credit card.

Second, a credit card holder may need to give money to a family member for shopping or other purposes. If handing over the credit card itself is not an option, the only available method is often to give cash.

Third, many people prefer to receive money without creating a digital trace. This does not necessarily indicate any illegal activity or an attempt to evade tax reporting. Rather, it may stem from a philosophy that values personal freedom and the right not to be digitally tracked. It may also reflect a desire to avoid the inconvenience and expense of providing legitimate explanations for legally received funds that are not required to be reported.

The present invention addresses these and other problems by enabling the allocation of funds from a credit card account directly for the benefit and use of another person-such as a friend, family member, or service provider-even if that person is not part of the traditional credit card settlement system.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that depicts the system (1) with the credit card provider server (2), the processors (processing devices) (10), the credit card terminal (3), the computing device (5), the mobile phone (6) and the computer application (4).

### THE INVENTION

The main objective of the present invention is to provide a computer-implemented method for online allocation of money from a credit card account to an anonymous, unidentified person and for online automatic authorization of cardless, unidentified, and anonymous payment of the allocated money via a credit card terminal. The method includes one or more of the following means and steps:

Receive, over a telecommunication network (7), by a server of a credit card provider, online allocation requests for anonymous payments. Each allocation request is originating from a credit card account holder via an online credit card account interface (51). Each allocation request comprises an allocated amount of money and a non-registered mobile phone number, as specified and/or inserted by the account holder via the interface, and instructions to authorize a cardless payment using the allocated money, to be performed by an unidentified and anonymous person.

The terms “credit card provider server” and/or “server” in this disclosure and in the claims refer also to multiple servers or a plurality of servers operated by the credit card provider, including servers of third parties that provide services to the credit card provider, such as generating, sending, or verifying one-time passwords (OTP). The term “pending” refers to allocation requests and/or allocated amounts that have not yet been used for payments via credit card terminals. The term “credit card account”, as used in this disclosure and in the claims, refers to any type of account that enables the account holder to use funds for making payments via credit card terminals. The term “credit card”, as used in this disclosure and in the claims, refers to any type of credit card, debit card, gift card, prepaid card, or, more generally, any physical, digital, or virtual card used for payments-including recently popular virtual cards that may be downloaded to mobile phones, smartphones, or other payment-enabled devices, even where no physical “card” exists.

Automatically flag by pre-stored machine-readable instructions within the server each allocated amount in the allocated requests as authorized to be used in a cardless payment by an unidentified and anonymous person via a credit card terminal, conditioned on fulfillment of a sufficient requirement comprising the manual entry, at the credit card terminal, of the mobile phone number linked to a received allocation request and the one-time password (OTP) transmitted by the server to the associated mobile phone number. The authorization is valid solely upon fulfillment of a predefined condition that is sufficient to authorize the payment, the condition comprising manual entry, at a credit card terminal, of a mobile phone number associated with a corresponding allocation request and a one-time password (OTP) transmitted by the server to the associated mobile phone number.

The term “flag” or “flagging” refers to the act of marking or identifying something for special attention or further processing. In technical and banking contexts, it means setting a digital indicator (a flag) in a system to signal a particular status, condition, or action to be taken-such as flagging a transaction for review, security, or special handling. The term “manual” here and in the claims means manual and/or other data entry, by tapping, typing, transferring, wiring, and similar means and ways of entering numbers and data into an online terminal interface and/or a physical terminal.

Store the flagged allocation requests in a database, including the instructions to authorize cardless, unidentified, and anonymous payment via a credit card terminal using the allocated amounts.

Maintain the database with the stored flagged allocation requests pending execution.

Receive, over a telecommunication network (7), by the server, a manual entry of a mobile phone number transmitted from a credit card terminal during a process of cardless, unidentified, and anonymous payment via a credit card terminal. At this stage, the anonymous person, who is in fact the recipient of the money, the person to whom the credit card account holder allocated the money, needs only to approach a credit card terminal, enter the mobile phone number (that can be unregistered number in the credit card provider or even unregistered elsewhere at all) and starts the process of the anonymous cardless payment via the credit card terminal. The terminal is programmed to transmit this entry of such mobile phone number to the server.

Automatically match, by the server, the entered mobile phone number received from the credit card terminal with a mobile phone number associated with a pending flagged allocation request stored in the database using matching-executed comparison logic (21).

Generate, by the server (that is likely to be a third party server that provides such service), a one-time password (OTP) and send this OTP to the matched mobile phone number.

Receive, over the telecommunication network (7), by the server, a manual entry of the OTP transmitted from the terminal. In this stage, the anonymous person needs simply to enter to the terminal the OTP received to the mobile with the Subscriber Identification Module (SIM) associated with that mobile phone number for continuing the process of the payment. The terminal is programmed to send this OTP entry to the server.

Automatically match, by the server or the credit card terminal, the entered OTP with the sent OTP using matching-executed comparison logic (21).

Receive, by the server or the credit card terminal, a manual entry of a payment amount that is equal to or less than an allocated amount associated with the matched mobile phone number and stored in the database.

Automatically authorize, by the server or the credit card terminal, based on machine-executed verification of matched allocation data, the cardless payment of the allocated amount by an unidentified and anonymous person via the credit card terminal, upon fulfillment of the predefined condition that is sufficient to authorize the payment, the condition comprising manual entry, at the credit card terminal, of the specified mobile phone number and the OTP.

In this disclosure and the claims, the term “anonymous person” refers to an individual about whom nothing is known, beyond the specified mobile phone number, the allocation amount, and the fact that the credit card account holder allocates these funds to be used by entering this mobile phone number to credit card terminals. The term “anonymous payment” means a payment via a credit card terminal carried out by such an anonymous person-someone with no known personal or identifying information. The term “unidentified person” refers to an individual whose identifying details were not received, either during the collocation request or the payment process via the credit card terminal. Accordingly, the expression “unidentified payment” refers to a payment via a credit card terminal performed by an unidentified person.

One of the inventive aspects of the present invention lies in how the various elements cooperate in a specific and non-obvious way to achieve something new and useful: secure, anonymous, cardless, and IDless (unidentified) payment via a credit card terminal, using non-registered phone numbers and credit card provider-controlled, conditional OTP logic. This coordination is unconventional and not part of the prior art.

The present invention discloses technical effects related to allocating money from a credit card account to an anonymous, unidentified person and enabling a cardless, unidentified, and anonymous payment of the allocated money via a credit card terminal. It includes specific technical implementations, such as flagging the allocated requests to authorize cardless, anonymous, and IDless payment via credit card terminals.

The effect of this invention is to facilitate a new kind of credit card terminal interaction, where an anonymous, unidentified, cardless individual can pay for services and/or products, as well as a new form of secure peer-to-peer transfer of money from a credit card account to an unidentified, anonymous, and unregistered person for using the allocated amounts for payments via credit card terminals.

The application of the pre-stored machine-readable instructions enables the credit card terminals to execute payments of the allocated amounts without accessing, verifying, or storing personal identity data of persons performing the payment.

The invention makes the allocated amounts of the flagged allocation requests available for cardless, unidentified, anonymous payment via credit card terminals by an unregistered individual solely by manual entry of the specified non-registered mobile phone number and the one-time password (OTP) sent thereto, without processing or requiring personal identity data of a person performing the payment from the credit card account holders and from the credit card terminals during the process of payment.

The payment is performed solely through a predefined input sequence at the credit card terminal, the sequence comprising manual entry of the specified mobile phone number and the OTP, and enabling the payment without requiring, processing or processing personal identity data of the person performing the payment by either the credit card terminal or the credit card provider server.

For clarity, the term “IDless” and “unidentified” as used in this disclosure and in the claims refers to a payment via a credit card terminal in which no personal identification step is required at any point during the process, including submitting the allocation request, storing the request, and processing the payment. The person performing the payment is never required to identify himself. The only information needed is the manual entry of the specified phone number and the OTP sent to that number.

The method may be performed by processors (processing devices) (10) running on the servers (2) and the credit card terminals (3) that are programed to function and used for executing the method. The method may include the following steps and means, as stated above, and explained here below in a different angle:

This step is optionally, but in any case the credit card holder should use the relevant computer application (which is likely to run under the consent of the credit card provider, usually big banks): Receiving, by the one or more servers (2) from a computing device (5) of the credit card account owner (holder), a request to login to a computer application (4) (in which the credit card account holder have an online credit card account). The term “login” in this disclosure and in the claims means also to “logon” and therefore the request to login to the computer application may include the need to provide one or more security feature submitted by the credit card holder of the credit card account such as a password, a PIN, or a biometric as it is customary in this filed.

The term “computing device” (5) in this disclosure and in the claims means any kind of computer that includes an internet access, such as a smartphone, a mobile phone, a tablet, laptop, desktop and the like. The term “computer application” (4) literally means computer software applications that enable users and owners of credit card accounts to operate their account in an online manner. The term “the computing device (5) of the owner (holder)” means the device that he uses for entering the computer application.

This step is optionally, but in any case the owner should insert some identification to ensure that it is he that makes the request): Granting, by the one or more servers, authorization to said computing device of the owner to access to the computer application. The access to the computer application (or the completion of the request) may be in response to verifying that the submitted security feature match the profile security feature stored in the user profile in the server that run the computer application, as customary done when a person wishes to login to his account by a computer or to wire money to a third person.

Receiving, by the one or more servers, a request from the online account of the credit card account owner, by means of said computer application, to allocate the certain amount of money to the third party recipient so that he become authorized and able to make the IDless payment via the credit card terminal using the allocated amount of money upon entering said specific mobile phone number at the relevant credit card terminal. It is possible that the recipient will use the allocated money in a few payments that in total are limited to that allocated amount. Each payment requires an input in to the terminal of the specific mobile phone number that the credit card account owner specified as part of the request to allocate the amount of money to the third party recipient.

The computer application enables to set the amount of money that the owner wants to allocate from his account and the specific mobile phone number of that recipient (no need to give or get specific passwords in this stage for processing the payment). The credit card terminal account owner may need to add nothing beyond that. The owner should enter to the computer application the phone number of the recipient and the certain amount of money (and maybe to tap “Done” or “Send”) and by that he sends the request. The computer application may be designed in a way that it will enable the owner to determine whether the allocation of said money is reversible or irreversible. “Reversible” means that that the request can be canceled as to the part of the certain amount of money that yet was not used at that moment of cancelation, and determining by the one or more servers that said request is reversible; “Irreversible” means that the allocation cannot be canceled at all, and determining by the one or more servers that said request is irreversible. So, when recipient receives the message that the certain amount is irreversible he can see it as a certain amount that fully paid to him and not on a condition.

It is understood that the owner should enter a specific mobile phone number that its SIM is possessed by the third party recipient that he wishes to enable him to make the payment (or with access to that specific mobile phone number), and the owner knows that the method includes the step (the need) of the recipient to enter OTP phone verification that will be sent as Short Message Service (SMS) for example to the mobile phone with a SIM of that mobile phone (6) number of the recipient using that phone number. When recipient wishes to get money without tracing he can buy a SIM without providing identification, which is legal at many democratic countries as part of the personal freedom.

The computer application may be designed in a way that it will enable the owner to determine whether the allocation of said money can be canceled (reversible allocation) or whether from the moment he approves the allocation then it cannot be returned (irreversible allocation). Also, it is possible and desirable that, immediately after the allocation is made, the system that operates this method will send a message to the specified mobile phone number of the recipient informing him that the owner has allocated to him that certain amount of money and that the allocation can be canceled (revisable), or cannot be canceled (irreversible), and it is possible that the text message (SMS) will include a period of time within he must use the money otherwise the allocation will be canceled automatically (this for cases in which the recipient lost his SIM with that mobile phone number for example).

Receiving, by the terminal, (an entry) the input of the specific mobile phone number that is required in order for enabling (authorizing) the payment. In this step, when the recipient wishes to use the allocated money then he needs to enter his specific mobile phone number into the terminal. The terminal are fit for this mission if updating their program operation, such as, by adding an option to press a button or to tap on their touch screens to select option to process a payment by inserting (entering) phone number for example.

In response to the input of the specific mobile phone number in to the terminal, the one or more servers generate and transmit to the specific mobile phone number (to the mobile device in which the sim of this number is activated) an SMS or another type of message with the onetime password OTP (similar to phone verification). The fact that the OTP that enables the payment is generated and transmitted a moment of the payment and directly to the recipient is an important part and it is an effective protection mechanism.

Receiving, by the terminal, the input of the onetime password (OTP), means that the recipient needs to enter at the terminal the OTP for completing the payment.

Verifying, by the one or more servers or by the terminal, the onetime password (OTP) that was input in to the terminal matches the generated onetime password (OTP). The match can be done for example in the terminal itself (means that the one or more servers send the OTP also the terminal) or on the one or more servers. The verification can be done by comparing the entered OPT with the generated OTP, in the one or more servers, the terminal, or in a database located in the servers.

Before verifying the OTP or before authorizing the payment, it is desirable that the one or more servers will determine whether the payment amount (together with other payments done before) do not exceed the allocated amount.
authorizing and enabling, by the one or more servers or by the terminal, the payment. In general, authorization means that the payment is confirmed by the credit card provider.

The credit card provider can charge the credit card account of the owner for the allocated amount at any time and in several ways, for example: in the case of an irrevocable (irreversible) allocation, the credit card provider can charge the credit card account of the owner at the moment of the allocation for the entire allocation amount, or lock the allocation amount so that it will no longer be available for use by the credit card account owner and will charge the account upon using this money for actual payments. It is possible to charge the credit card account after each payment.

The manner and time of the charge can be made in several dates and ways. In other words, the request to allocate the money can be reversible, and in this case the servers or the computer applications enable the credit card account owner to cancel the allocation. Another option of the method, the request to allocate the amount of money cab be irreversible, and in such case the servers or the computer applications limiting the credit card account owner to cancel the allocation (means, that in the regular standard options the owner is disabled from having the option to cancel such irreversible allocation, but he may have the option to do so throng a specific request that will be decided by a representative of the credit card company in a certain special cases). In response to irreversible request, the method may send a message to the specific mobile phone number stating that the allocation of that certain amount of money is irreversible.

The method can be designed to enable the recipient to use the money for payments via a credit card terminal, in one payment or in several payments. Also, the method can be designed to enable to include the possibility that in case that several amounts have been assigned (allocated) to the same phone number by several people (credit card account owners), then the details of the senders can be displayed on the terminal's display (after inserting the OTP) and the recipient will be given the option to choose from whom to process the payment. It is possible and desirable that after each payment, both the credit card account owner and the recipient will receive a message from the servers informing them that a payment has been approved for x amount and that the remaining balance for payments is y for example.

The method can be executed by the system (1) and another objective of the present invention is to provide the computer system for enabling the owner of the credit card account to allocate a certain amount of money to a third party recipient, such that the third party recipient is authorized and enabled to (cardless) payment using the allocated amount via credit card terminal (3). The third party recipient is able and authorized to make the payment by input the specified mobile phone number that the owner entered along the allocation request. In general the parts of the system are same to the parts and steps of the method and there is no need to repeat theme.

The communications means and methods between the computing devices, the servers, the credit card terminals, the computer application, are known to experts in the field and therefore there is no need to describe them in details in this disclosure.

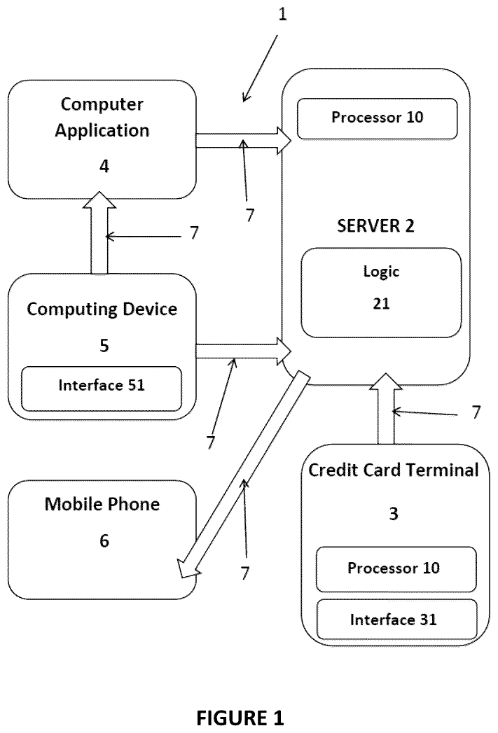

FIG. 1 is a block diagram that schematically depicts the system (1) with the server (2), the processors (processing devices) (10), the credit card terminal (3) with its user interface and input mechanism (31) for entering the specific mobile phone number and the OTP, the computing device (5) of the credit card account holder/owner, the mobile phone with the SIM (6) of the recipient and the computer application (4).

What is claimed is:

1. A computer-implemented method for online authorization, over a telecommunication network, of a cardless payment via a credit card terminal by an unidentified and anonymous person using allocated money from a credit card account, the method comprising:
receiving, over a telecommunication network, by a server of a credit card provider, allocation requests for anonymous payments transmitted by credit card account holders via an online credit card account interface, each allocation request comprising an allocated amount of money, a non-registered mobile phone number, and instructions to authorize a cardless payment via a credit card terminal by an unidentified and anonymous person using the allocated amount;
automatically flagging, by execution of pre-stored machine-readable instructions within the server, each allocated amount as authorized to be used in a cardless payment by an unidentified and anonymous person via a credit card terminal, conditioned on fulfillment of a sufficient requirement comprising manual entry, at a credit card terminal, of a mobile phone number linked to a received allocated request and a one-time password (OTP) transmitted by the server to the linked mobile phone number;
storing the flagged allocation requests in a database connected to the telecommunication network, each including instructions to authorize a cardless payment by an unidentified and anonymous person via a credit card terminal using the allocated amount;
maintaining the database with the stored flagged allocation requests pending execution;
receiving, over the telecommunication network, by the server, a manual entry of a mobile phone number transmitted from a credit card terminal during a process of cardless payment by unidentified and anonymous person via the credit card terminal;
automatically matching, within the server, the entered mobile phone number received from the credit card terminal with a mobile phone number associated with a pending flagged allocation request stored in the database using machine-executed comparison logic;
generating, by the server, a one-time password (OTP) and sending the OTP to the matched mobile phone number;
receiving, by the server over the telecommunication network, a manual entry of the OTP transmitted from the credit card terminal;
automatically matching, within the server or the credit card terminal, the entered OTP with the sent OTP using machine-executed comparison logic;
receiving, by the server or the credit card terminal, a manual entry of a payment amount that is equal to or less than an allocated amount linked with the matched mobile phone number and stored in the database; and
automatically authorizing, by the server or the credit card terminal, based on machine-executed verification of matched allocation data, the cardless payment of the allocated amount by an unidentified and anonymous person via the credit card terminal, conditioned on fulfillment of the sufficient requirement comprising the manual entry of the linked mobile phone number and the OTP.
